(19) United States
(12) Patent Application Publication
(10) Pub. No.: US 2017/0129484 A1
(43) Pub. Date: May 11, 2017

(54) AUTO-PARKING SYSTEM

(71) Applicant: Leauto Intelligent Technology (BEIJING) Co.Ltd, Beijing (CN)

(72) Inventors: WenRui LI, Beijing (CN); Yong XU, Beijing (CN); Yu ZOU, Beijing (CN); KunSheng CHEN, Beijing (CN); Wei LIN, Beijing (CN); Peng LIU, Beijing (CN); Dan LI, Beijing (CN); XiaoFei GOU, Beijing (CN)

(73) Assignee: Leauto Intelligent Technology (BEIJING) Co.Ltd, Beijing (CN)

(21) Appl. No.: 14/973,707

(22) Filed: Dec. 17, 2015

(30) Foreign Application Priority Data
Nov. 9, 2015 (CN) 2015107573719

(51) Int. Cl. B60W 30/06; B60W 10/30; B60W 10/10; G05D 1/00; B60W 10/20

(52) U.S. Cl. CPC B60W 30/06; G05D 1/0022; B60W 10/20; B60W 10/10; B60W 10/30; B60W 2550/308; B60W 2550/22; B60W 2720/24; B60W 2720/10; B60W 2710/20; B60W 2710/1094; B60W 2420/42; B60W 2420/52

(57) ABSTRACT

The present disclosure provides an auto-parking system. The system includes a data acquiring unit, a center-processing unit, and a vehicle control unit, wherein the data acquiring unit and the center-processing unit may be provided in a parking lot, the vehicle control unit may be provided in the vehicle, the center-processing unit may be communicationally connected with the data acquiring unit in a wired way, and the center-processing unit may be communicationally connected with the vehicle control unit in a wireless way. The auto-parking system provided by the present disclosure may reduce the parking cost for the user of the vehicle, since it is necessary for each vehicle to only install a vehicle control unit.

### CROSS-REFERENCE TO RELATED APPLICATIONS

This application claims priority to Chinese Patent Application No. 201510757371.9, with the title of “ [symbol] ” (Auto-Parking System), filed on Nov. 9, 2015, which is hereby incorporated by reference in its entirety.

### TECHNICAL FIELD

The present disclosure relates to vehicle technique, and more particularly to an auto-parking system.

It may be an essential capability for a driver to drive a vehicle into a small and narrow space quickly and properly since there is limited space for parking in big cities. A driver with bad capability of parking may cause traffic jam, tired in nervousness and vehicle scratching and so on. As the development of the technology, there appears an auto-parking function, which refers to a function enabling a vehicle to park in place automatically without a manned control.

In related art, the auto-parking system may be installed on a vehicle and generally includes a data acquiring unit, a center-processing unit and a vehicle control unit. More particularly, the data acquiring unit may acquire environment data of vehicle's surroundings, the center-processing unit may make analysis on the acquired data, and the vehicle control unit may perform auto-control on the vehicle according to an analysis result, to enable the vehicle to ride into a designated parking place, so that the auto-parking function may be achieved.

However, there are at least following problems in the related art: it is necessary for each vehicle to install a set of auto-parking system for implementation of the auto-parking function, therefore the parking cost may be high.

### SUMMARY

The present disclosure provides an auto-parking system so as to reduce the parking cost.

To achieve the above object, the embodiment of the present disclosure may provide the following technical solutions.

In the first aspect, the present disclosure provides an auto-parking system, including a data acquiring unit, a center-processing unit, and a vehicle control unit, wherein the data acquiring unit and the center-processing unit may be provided in a parking lot, the vehicle control unit may be provided in the vehicle, the center-processing unit may be communicationally connected with the data acquiring unit in a wired way, and the center-processing unit may be communicationally connected with the vehicle control unit in a wireless way.

The auto-parking system provided by the present disclosure may reduce the parking cost for the user of the vehicle, since it is necessary for each vehicle to only install a vehicle control unit. Furthermore, since the data acquiring unit and the center-processing unit provided in a parking lot may perform centralized management on several or tens of parking place without requiring provision of a plurality of data acquiring units and center-processing units, the parking cost may be reduced for a user of vehicle or an operator of the parking lot.

### BRIEF DESCRIPTION OF THE DRAWINGS

FIG. 1 is a structural block diagram of an embodiment of the auto-parking system provided by the present disclosure;

FIG. 2 is an application scenario of the auto-parking system of the embodiment shown in FIG. 1; and

FIG. 3 is another structural block diagram of an embodiment of the auto-parking system provided by the present disclosure.

### DESCRIPTION OF THE EMBODIMENTS

In the following, detailed description may be made on the auto-parking system of the embodiments of the present disclosure in connection with drawings.

### First Embodiment

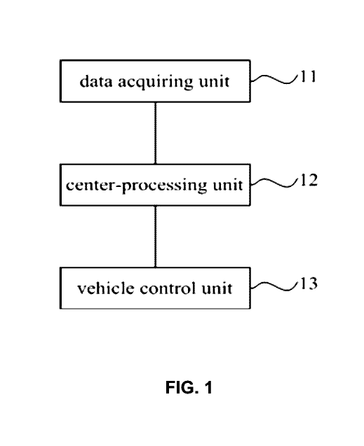

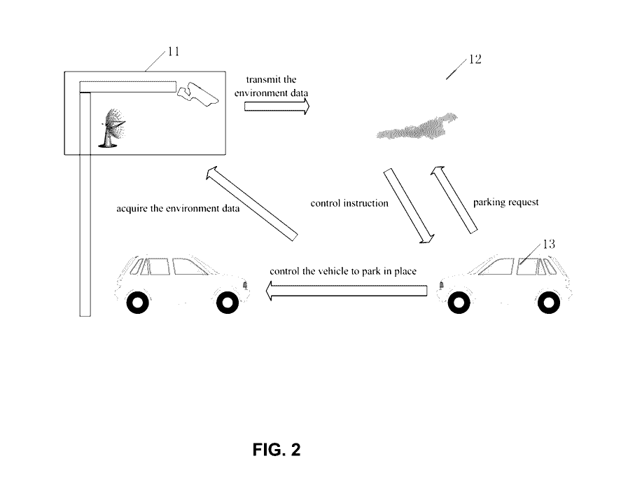

FIG. 1 is a structural block diagram of an embodiment of the auto-parking system provided by the present disclosure. FIG. 2 is an application scenario of the auto-parking system of the embodiment shown in FIG. 1. As shown in FIG. 1 and FIG. 2, the auto-parking system of the embodiment of the present disclosure may include a data acquiring unit 11, a center-processing unit 12, and a vehicle control unit 13.

The data acquiring unit 11 and the center-processing unit 12 may be provided in a parking lot, the vehicle control unit 13 may be provided in the vehicle, the center-processing unit 12 may be communicationally connected with the data acquiring unit 11 in a wired way, and the center-processing unit 12 may be communicationally connected with the vehicle control unit 13 in a wireless way.

More particularly, the center-processing unit 12 may be communicationally connected with the data acquiring unit 11 in a wired way, so as to ensure the accuracy and performance of real-time of transmission procedures. The center-processing unit 12 may be communicationally connected with the vehicle control unit 13 in a wireless way so as to achieve the convenience and quickness. The data acquiring unit 11 and the center-processing unit 12 may be provided as fundamental equipments of a parking lot and it is necessary for each vehicle to only install a vehicle control unit 13 for auto-parking so that the parking cost for the user of the vehicle may be reduced. Furthermore, although the provision of the data acquiring unit and the center-processing unit may increase some cost for an operator of the parking lot, the data acquiring unit 11 and the center-processing unit 12 may perform centralized management on several or tens of parking place without requiring provision of a plurality of data acquiring units 11 and center-processing units 12, the parking cost may be reduced for a user of vehicle or an operator of the parking lot.

Furthermore, the wired way as mentioned above may a wired Ethernet way. The wireless way as mentioned above may include, but not limited to, mobile wireless communication or Vehicle to Everything (V2X) communication way. More particularly, the mobile wireless communication way may include, but not limited to, 2nd Generation (2G) mobile communication way, 3rd Generation (3G) mobile communication way, and 4th Generation (4G) mobile communication way.

Furthermore, the data acquiring unit 11 may be configured to acquire the environment data of vehicle's surroundings and transmit the same to the center-processing unit 12. The vehicle control unit 13 may be configured to transmit a parking request to the center-processing unit 12 and control the vehicle according to a received control instruction. The center-processing unit 12 may be configured to receive the parking request and environment data, and generate control instructions according to the environment data and transmit it to the vehicle control unit 13.

More particularly, the auto-parking system of the embodiment of the present disclosure may implement the auto-parking function as follows: when a vehicle goes into a parking lot, the vehicle control unit 13 may transmit a parking request to the center-processing unit 12. The data acquiring unit 11 may acquire the environment data of vehicle's surroundings in real-time and transmit it to the center-processing unit 12. The center-processing unit 12 may receive the parking request transmitted by the vehicle control unit 13 and the environment data transmitted by the data acquiring unit 11, and perform centralized management according to the environment data to plan the optimized parking place, and generate a control instruction according to the environment data so as to be transmitted to the vehicle control unit 13. The vehicle control unit 13 may receive the control instruction transmitted by the center-processing unit 12 and making analysis on the control instruction and perform corresponding control on the vehicle according to the control instruction. The above procedure may be repeated, and during repeating of the procedure, the environment data may be updated and the control instruction may be changed, so that the vehicle may be parked into a desired parking place gradually so as to implement the auto-parking function.

The auto-parking system provided by the present disclosure may reduce the parking cost for the user of the vehicle, since it is necessary for each vehicle to only install a vehicle control unit. Furthermore, since the data acquiring unit and the center-processing unit provided in a parking lot may perform centralized management on several or tens of parking place without requiring provision of a plurality of data acquiring units and center-processing units, the parking cost may be reduced for a user of vehicle or an operator of the parking lot.

### Second Embodiment

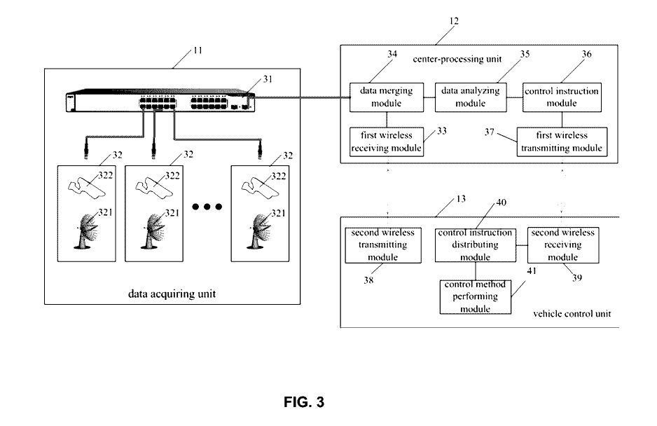

FIG. 3 is another structural block diagram of an embodiment of the auto-parking system provided by the present disclosure. As shown in FIG. 3, the auto-parking system of the embodiment of the present disclosure may be a possible implementation of the auto-parking system of the first embodiment. On the basis of the first embodiment, the data acquiring unit 11 may include a switch 31 and at least one sensor module 32.

The switch 31 may be connected with the sensor module 32 and the center-processing unit 12 via Ethernet communication.

The sensor module 32 may be configured to acquire environment data of the vehicle's surroundings and transmit the same to the switch 31.

The switch 31 may be configured to transmit the environment data to the center-processing unit 12.

More particularly, the environment data may include, but not limited to, position data of vehicle, data of number of unoccupied parking places, data of distance between vehicle and surroundings and/or data of traffic marks. The data of traffic marks may include, but not limited to, data of boarder-line of parking place and/or data of indication for turning left or right.

Furthermore, the sensor module 32 may include a radar 321 and/or a camera 322 or the like. Since the radar 321 may be expensive, it is possible to reduce the cost for parking greatly by providing the data acquiring unit 11 inside the parking lot. When the data acquiring unit 11 is provided inside the parking lot, positions and heights for installation of the radar 321 and/or camera 322 may be not limited by the height of vehicle any more, which means more flexibility and better visual field may be provided and a better guiding route for parking in place may be provided so as to avoid the scratching during auto-parking.

Furthermore, the center-processing unit 12 may include a first wireless receiving module 33, a data merging module 34, a data analyzing module 35, and a control instruction module 36, and a first wireless transmitting module 37.

The data merging module 34 may be connected with the first wireless receiving module 33 and the data analyzing module 35 respectively. The control instruction module 36 may be connected with the data analyzing module 35 and the first wireless transmitting module 37 respectively. The first wireless receiving module 33 and the first wireless transmitting module 37 may be connected with the vehicle control unit 13 via wireless communication, and the data merging module 34 may be connected with the data acquiring unit 11 via wired communication.

The first wireless receiving module 33 may be configured to receive a parking request and transmit the parking request to the data merging module 34.

More particularly, the first wireless receiving module 33 may receive the parking request transmitted by the vehicle control unit 13 via an air interface.

The data merging module 34 may be configured to receive a parking request and environment data, and perform merging processing on the environment data to obtain whole-position data, and transmit the whole position data to the data analyzing module 35.

More particularly, the data merging module 34 may perform merging processing on the environment data acquired by a plurality of sensor modules 32 in the data acquiring unit 11 by means of image processing or the like, so as to remove overlapping data, to obtain whole-position data.

The data analyzing module 35 may be configured to perform analysis on the whole-position data to obtain an analysis result data, and transmit the analysis result data to the control instruction module 36.

More particularly, the data analyzing module 35 may perform analysis on the whole-position data and perform calculation to obtain the analysis result data, such as position of vehicle with respect to surroundings, distance data and so on.

The control instruction module 36 may be configured to generate a control instruction according to the analysis result data and transmit the control instruction to the first wireless transmitting module 37.

More particularly, the control instruction module 36 may perform calculating according to the analysis result data, such as position of vehicle with respect to surroundings, distance data and so on to obtain the position data of unoccupied vehicle place and generate the control instruction including a going-forward instruction, a going-backward instruction, a turning-left instruction, and a turning-right instruction, a turning-angle of steering-wheel instruction, and/or vehicle speed instruction or the like.

The first wireless transmitting module 37 may be configured to transmit the control instruction to the vehicle control unit 13.

More particularly, the first wireless transmitting module 37 may transmit the control instructions to the vehicle control unit 13 via an air interface according to a specified communication channel and speed.

Furthermore, the vehicle control unit 13 may include a second wireless transmitting module 38, a second wireless receiving module 39, a control instruction distributing module 40, and at least one control method performing module 41.

The control instruction distributing module 40 may be connected with a second wireless receiving module 39 and a control method performing module 41 respectively, and the second wireless receiving module 39 and the second wireless transmitting module 38 may be connected with the center-processing unit 12 via wireless communication respectively.

The second wireless transmitting module 38 may be configured to transmit a parking request to the center-processing unit 12.

More particularly, the second wireless transmitting module 38 may transmit the control instructions to the center-processing unit 12 via an air interface according to a specified communication channel and speed.

The second wireless receiving module 39 may be configured to receive a control instruction and transmit the control instruction to the control instruction distributing module 40.

More particularly, the second wireless receiving module 39 may receive the control instruction transmitted by the center-processing unit 12 via an air interface.

The control instruction distributing module 40 may be configured to perform analysis on the control instruction to obtain the control method, and transmit the control method to a corresponding control method performing module 41.

More particularly, the control instruction distributing module 40 may perform analysis on the control instructions to obtain the control methods including controlling gear-changer to change to reverse gear, controlling the turning light to be turned on or off, and/or controlling the steering-wheel to change steering angle, or the like.

The control method performing module 41 may be configured to control the vehicle according to the received control method.

More particularly, the control method performing module 41 may be an Electronic Control Unit (simply referred as “ECU”), and the ECU may also be referred as “driving computer”, “on-vehicle computer”, or the like.

It should be noted that, the functions of the first wireless transmitting module 37 and the first wireless receiving module 33 in the center-processing unit 12 may be integrated into one wireless transceiving module. Similarly, the functions of the second wireless transmitting module 38 and the second wireless receiving module 39 in the vehicle control unit 13 may be also integrated into one wireless transceiving module.

The auto-parking system provided by the present disclosure may reduce the parking cost for the user of the vehicle, since it is necessary for each vehicle to only install a vehicle control unit. Furthermore, since the data acquiring unit and the center-processing unit provided in a parking lot may perform centralized management on several or tens of parking place without requiring provision of a plurality of data acquiring units and center-processing units, the parking cost may be reduced for a user of vehicle or an operator of the parking lot.

One skilled in the art would appreciate that all or a part of the steps for implementing the foregoing method embodiments may be implemented by hardware related to program instructions. Foregoing programs may be stored in computer-readable storage medium, and upon being executed, such programs may perform the steps including foregoing method embodiments; and examples of foregoing storage medium include ROM, RAM, CD-ROM, a magnetic tape, and the other types of storage mediums which may store the program codes.

It should be noted that the foregoing embodiments are merely used to illustrate the technical solution of the present disclosure, and not to limit the present disclosure. Although the present disclosure has been described in detail with reference to the foregoing embodiments, one skilled in the art would understand that the technical solutions recited in the foregoing embodiments may be modified or all or a part of the technical features may be replaced equally. These modifications and replacements are not intended to make corresponding technical solution depart from the scope of the technical solution of embodiments of the present disclosure.

What is claimed is:

1. An auto-parking system, comprising: a data acquiring unit, a center-processing unit, and a vehicle control unit,
wherein the data acquiring unit and the center-processing unit are provided in a parking lot, the vehicle control unit is provided in the vehicle, the center-processing unit is communicationally connected with the data acquiring unit in a wired way, and the center-processing unit is communicationally connected with the vehicle control unit in a wireless way.

2. The auto-parking system according to claim 1, wherein the wired way is a wired Ethernet way, and the wireless way comprises mobile wireless communication or Vehicle to Everything (V2X) communication way.

3. The auto-parking system according to claim 1, wherein the data acquiring unit is configured to acquire environment data of vehicle's surroundings and transmit the environment data to the center-processing unit,
the vehicle control unit is configured to transmit a parking request to the center-processing unit and control the vehicle according to a received control instruction, and
the center-processing unit is configured to receive the parking request and the environment data, and generate control instructions according to the environment data and transmit the control instructions to the vehicle control unit.

4. The auto-parking system according to claim 3, wherein the data acquiring unit further comprises a switch and at least one sensor module,
the switch is connected with the sensor module and the center-processing unit via Ethernet communication,
the sensor module is configured to acquire environment data of the vehicle's surroundings and transmit the environment data to the switch, and
the switch is configured to transmit the environment data to the center-processing unit.

5. The auto-parking system according to claim 3, wherein the center-processing unit further comprises a first wireless receiving module, a data merging module, a data analyzing module, and a control instruction module, and a first wireless transmitting module,
the data merging module is connected with the first wireless receiving module and the data analyzing module respectively, the control instruction module is connected with the data analyzing module and the first wireless transmitting module respectively, the first wireless receiving module and the first wireless transmitting module is connected with the vehicle control unit via wireless communication respectively, and the data merging module is connected with the data acquiring unit via wired communication,
the first wireless receiving module is configured to receive a parking request and transmit the parking request to the data merging module,
the data merging module is configured to receive the parking request and the environment data, and perform merging processing on the environment data to obtain whole-position data, and transmit the whole position data to the data analyzing module,
the data analyzing module is configured to perform analysis on the whole-position data to obtain an analysis result data, and transmit the analysis result data to the control instruction module,
the control instruction module is configured to generate a control instruction according to the analysis result data and transmit the control instruction to the first wireless transmitting module, and
the first wireless transmitting module is configured to transmit the control instruction to the vehicle control unit.

6. The auto-parking system according to claim 3, wherein the vehicle control unit comprises a second wireless transmitting module, a second wireless receiving module, a control instruction distributing module, and at least one control method performing modules,
the control instruction distributing module is connected with the second wireless receiving module and the control method performing module respectively, and the second wireless receiving module and the second wireless transmitting module is connected with the center-processing unit via wireless communication respectively,
the second wireless transmitting module is configured to transmit the parking request to the center-processing unit,
the second wireless receiving module is configured to receive the control instruction and transmit the control instruction to the control instruction distributing module,
the control instruction distributing module is configured to perform analysis on the control instruction to obtain the control method, and transmit the control method to a corresponding control method performing module, and
the control method performing module is configured to control the vehicle according to the received control method.

7. The auto-parking system according to claim 3, wherein the environment data comprises position data of the vehicle, data of number of unoccupied parking places, data of distance between vehicle and surroundings and/or data of traffic marks.

8. The auto-parking system according to claim 7, wherein the data of traffic marks comprises data of boarder-line of parking place and/or data of indication for turning left or right.

9. The auto-parking system according to claim 3, wherein the control instruction comprises a going-forward instruction, a going-backward instruction, a turning-left instruction, and a turning-right instruction, a turning-angle of steering-wheel instruction, and/or a vehicle speed instruction.

10. The auto-parking system according to claim 6, wherein control methods comprises controlling gear-changer to change to reverse gear, controlling the turning light to be turned on or off, and/or controlling the steering-wheel to change steering angle.

11. The auto-parking system according to claim 4, wherein the sensor module comprises radar and/or a camera.

12. The auto-parking system according to claim 6, wherein control method performing module is an Electronic Control Unit (ECU).
